(19) United States
(12) Patent Application Publication
(10) Pub. No.: US 2015/0015711 A1
(43) Pub. Date: Jan. 15, 2015

(54) METHOD AND CAMERA ASSEMBLY FOR DETECTING RAINDROPS ON A WINDSCREEN OF A VEHICLE

(71) Applicants: Samia Ahiad, Gagny (FR); Caroline Robert-Landry, Paris (FR)

(72) Inventors: Samia Ahiad, Gagny (FR); Caroline Robert-Landry, Paris (FR)

(73) Assignee: VALEO Schalter und Sensoren GmbH, Bietigheim-Bissingen (DE)

(21) Appl. No.: 14/343,445

(22) PCT Filed: Sep. 7, 2011
(86) PCT No.: PCT/EP2011/004507

§ 371 Date: Jun. 30, 2014

(51) Int. Cl. B60S 1/08

(52) U.S. Cl. CPC B60S 1/0844; B60W 2550/12
USPC 348/148

(57) ABSTRACT

The invention relates to a method for detecting raindrops (26) on a windscreen of a vehicle, in which at least one image (30, 32, 34) is captured by a camera. An object extracted from the at least one image (30, 32, 34) captured by the camera is identified as a raindrop (26), if a confidence value assigned (S20) to the extracted object is above a predetermined threshold value. The threshold value is modified (S22) in dependence of the presence of an item (16) within the vehicle path. Moreover the invention relates to a camera assembly for detecting raindrops (26) on a windscreen of a vehicle.

The invention relates to a method for detecting raindrops on a windscreen of a vehicle, in which at least one image is captured by a camera. Moreover, the invention relates to a camera assembly for detecting raindrops on a windscreen of a vehicle.

For motor vehicles, several driving assistance systems are known, which use images captured by a single or by several cameras. The images obtained can be processed to allow a display on screens, for example at the dashboard, or they may be projected on the windscreen, in particular to alert the driver in case of danger or simply to improve his visibility. The images can also be utilized to detect raindrops or fog on the windscreen of the vehicle. Such raindrop or fog detection can participate in the automatic triggering of a functional units of the vehicle. For example the driver can be alerted, a braking assistance system can be activated, windscreen wipers can be turned on and/or headlights can be switched on, if rain is detected.

Raindrop detection on a windscreen of a vehicle based on an image captured by a camera may encounter some difficulties due to a misinterpretation of objects extracted from the image captured by the camera as raindrops.

It is therefore the object of the present invention to create a method and a camera assembly for detecting raindrops on a windscreen of a vehicle, which is particularly reliable.

This object is met by a method with the features of claim 1 and by a camera assembly with the features of claim 11. Advantageous embodiments with convenient further developments of the invention are indicated in the dependent claims.

According to the invention, in a method for detecting raindrops on a windscreen of a vehicle, at least one image is captured by the camera. An object extracted from the at least one image captured by the camera is identified as a raindrop, if a confidence value assigned to the extracted object is above a predetermined threshold value. The confidence value indicates the probability that the object in question is in fact a raindrop and not another object. In the present method the threshold value is modified in dependence of the presence of an item within the vehicle path. This is based on the finding that an item which is relatively near to the camera may lead to a misinterpretation of parts of the item as raindrops due to the characteristics of these parts in the image, which are similar to the characteristics of a raindrop in the image. By modifying the threshold value in case that an item is present within the vehicle path, a confusion of objects extracted from the image, which are non-drops with actual raindrops can be avoided at least to a large extent. Therefore modifying the threshold value leads to a more reliable detection of raindrops on the windscreen of the vehicle. The item does not necessarily need to be detected as such within the image. In some alternative, the detected item within vehicle path may even be outside the camera's field of view while usually close to it. In that case, the item can nevertheless affect raindrop detection due to some possible impediment coming from e.g. a light source at the item like back light of a leading vehicle scattering light within camera's field of view. Even if the light source is not within camera's field of view while the item being within vehicle path, some scattered light can be detected by the camera which may lead to some misinterpretation for raindrop detection.

In an advantageous embodiment of the invention the threshold value is increased, if the distance between the camera and the item is lower than a predetermined distance. This is due to the fact that an object which is far from the camera appears rather blurred when the camera is configured to detect raindrops on the windscreen. Consequently, when an object is rather close an image of that object is quite sharp. This may lead to confusion with raindrops on the windscreen, which also appear sharp in an image of the windscreen. By increasing the threshold value only objects extracted from the image, which yield a high probability of being a raindrop are actually identified as raindrops. By increasing the threshold value with the item being rather close to the camera false detections because of similar characteristics of parts of the item with raindrops can be avoided.

As the distance between the item and the camera depends on the position of the camera within the vehicle and on the size of the vehicle it is also possible to increase the threshold value, if the distance between the vehicle and the item is lower than a predetermined distance. Moreover, the distance between the vehicle and an item or obstacle can rather easily be determined, for example by parking assistance means.

With the threshold value modified in case an item is present within the camera's field of view, the raindrop can easily be identified if a contour and/or the contrast and/or an intensity of the extracted object is considered. Such characteristics of the objects extracted from the image are readily determinable and yield good detection results.

It has further turned out to be advantageous, when the presence of the item within the camera's field of view is determined by means of the camera. In this case no other detection means needs to be provided in order to determine the presence of the item or the distance between the item and the camera.

If at least two cameras are present, it is also possible to obtain data on the item with one camera and capturing the image for raindrop detection with the other camera. It is also possible to obtain data on the item with only one camera which is exclusively focused on the windscreen in order to detect raindrops on the windscreen.

Alternatively or additionally, the presence of the item within the vehicle path can be determined by a detection means configured to emit and receive a signal reflected by the item. Especially, if a vehicle is equipped with such a detection means, for example an ultrasonic detector and/or a radar detector, utilized for other driving assistance functions such as parking assistance, the data obtained by these detection means can easily be utilized in order to detect the presence of the item within the vehicle path allowing even the detection of item outside the camera's field of view still disturbing for raindrop detection.

In another advantageous embodiment of the invention the image is captured by a bifocal camera, wherein the raindrop detection is performed for objects extracted from the image area of a captured image, which is focused on the windscreen. Such a bifocal camera allows raindrop detection on one hand and another driving assistance functions based on the same captured image on the other hand. Furthermore, only one camera is thus needed for performing several driving assistance functions.

The presence of the item can easily be determined within another image area of the captured image, which is focused at infinity. With information obtained from this other image area with a focus different to the image area utilized for raindrop detection, the presence and/or the distance of the item within the field of view of the camera can easily be determined.

A supervised learning machine can be utilized to identify raindrops among objects extracted from the at least one image. Such a supervised learning machine, for example a support vector machine is particularly powerful in identifying raindrops.

Finally, it has turned out to be advantageous, if the threshold value is reset to a predetermined value, if the item is no longer present within the vehicle path or camera's field of view. With the disappearance of the item from the vehicle path, the probability of confusing parts of the item with raindrops actually present on the windscreen is no longer given, and there is no need for modifying the threshold value any longer.

It is also possible to interrupt the detection process for a period during which the item is present within the vehicle path or camera's field of view.

The camera assembly according to the invention, which is configured for detecting raindrops on a windscreen of a vehicle, comprises a camera for capturing at least one image. The camera assembly further comprises evaluation means configured to identify an object extracted from the at least one image captured by the camera as a raindrop, if the confidence value assigned to the extracted object is above a predetermined threshold value. The evaluation means is also configured to modify the threshold value in dependence of the presence of an item within the camera's field of view. Such a camera assembly is particularly reliable in detecting raindrops on the windscreen, as confusion of parts of the item with raindrops can be avoided by modifying the threshold value.

The preferred embodiments presented with respect to the method for detecting raindrops and the advantages thereof correspondingly apply to the camera assembly according to the invention and vice versa.

All of the features and feature combinations mentioned in the description above as well the features and feature combinations mentioned below in the description of the figures and/or shown in the figures alone are usable not only in the respectively specified combination, but also in other combinations or else alone without departing from the scope of the invention.

Further advantages, features and details of the invention are apparent from the claims, the following description of preferred embodiments as well as from the drawings. Therein show:

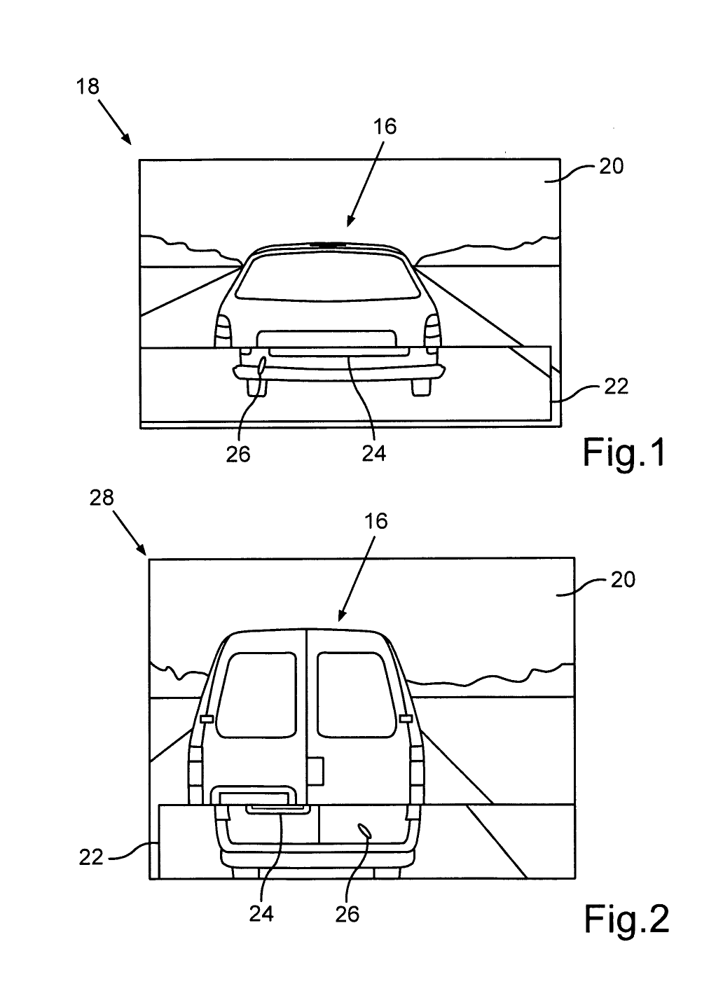

FIG. 1 a first image taken by a bifocal camera installed within the cabin of a vehicle, wherein a lower part of the image is focused on the windscreen and contains objects which may be confused with raindrops on the windscreen,

FIG. 2 another image of a similar situation, wherein the presence of a vehicle in front of the vehicle equipped with the bifocal camera may lead to a false detection of raindrops on the windscreen;

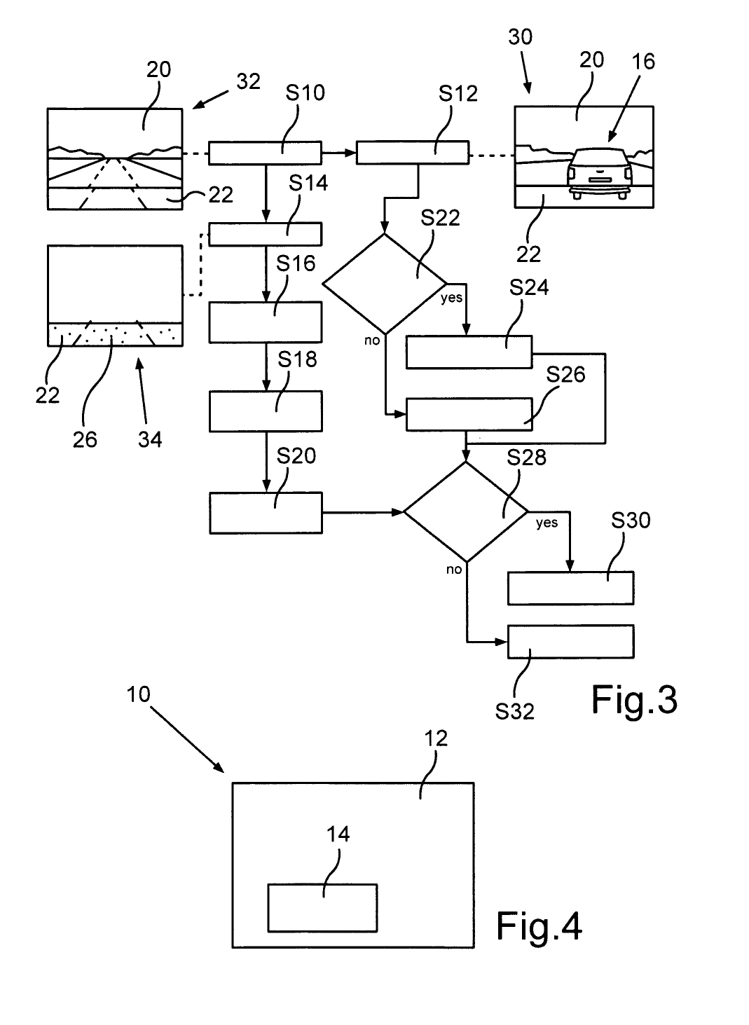

FIG. 3 a flow chart indicating a method for detecting raindrops on the windscreen, wherein a threshold value defining a level of confidence for identifying an object as a raindrop is increased in case of the presence of an item in the camera's near field of view; and

FIG. 4 very schematically a camera assembly configured to perform the detection of raindrops on the windscreen.

A camera assembly 10 (see FIG. 4) for detecting raindrops on a windscreen of vehicle comprises a camera 12 which may include a CMOS or a CCD image sensor and is configured to view the windscreen of the vehicle. The camera 12 is a bifocal camera which is focused on the windscreen of the vehicle and focused at infinity. Thus the camera 12 which is installed inside a cabin of the vehicle is configured to view objects on the windscreen of the vehicle.

The windscreen can be wiped with the aid of the wiper blades in case the camera assembly 10 detects raindrops on the windscreen. The camera 12 captures images of the windscreen and through image processing it is determined whether objects on the windscreen are raindrops or not.

The camera assembly 10 comprises evaluation means 14 (see FIG. 4) which are configured to identify an object extracted from the image captured by the camera 12 as a raindrop. For this evaluation a confidence value which is assigned to the extracted object is compared to a threshold value. The confidence value indicates the probability that an object within an image captured by the camera 12 is a raindrop. For example, after classification of the objects extracted from the image, to each object a confidence value is assigned that can vary between −100 and 100. In this case the value of 100 is the maximum confidence value or score for identifying the object as a raindrop. The value of −100 is the minimum confidence value which leads to rejection of the object as a non-drop. If the threshold value is set to 0, each object with a confidence value above 0 is identified as a raindrop and each object with a negative confidence value is identified as a non-drop.

However, items or obstacles such as a vehicle 16 in front of the vehicle in which the camera assembly 10 is installed can lead to difficulties in detecting raindrops.

FIG. 1 shows an image 18 captured by the bifocal camera 12. An upper part 20 or image area of the captured image 18 is focused to infinity and the vehicle 16 in front of the vehicle is mainly situated in this upper part 20 of the image 18. A lower part 22 or lower image area of the image 18 is focused on the windscreen of the vehicle equipped with the camera assembly 10.

A part of the vehicle 16 in front of the vehicle equipped with the camera 12 comes to lie within the lower part 22 of the image 18. Parts 24 of that vehicle 16 such as parts of the bumper or tail lamps of this vehicle 16 are rather close to the vehicle equipped with the camera 12. Therefore, these parts 24 which are located within the camera's 12 field of view appear as rather sharp objects within the lower part 22 of the image 18. Similarly raindrops 26 within the lower part 22 of the image 18 also have a sharp contour as a feature which usually leads to the identification of such extracted objects as raindrops 26.

As a part 24 of the vehicle 16 such as a tail lamp may appear similar a raindrop 26, it becomes difficult to distinguish these objects in the image 18, whenever an item such as the vehicle 16 is present within the field of view of the camera 12, especially when the item or vehicle 16 is rather close. Contrasted and sharp characteristics of these parts 24 of the vehicle 16 in the lower part 22 of the image 18 may lead to confusing them with raindrops 26. Also, a raindrop on the windscreen, which is enlightened by the close vehicle's 16 tail lamp may display characteristics similar to a tail lamp, for example a high intensity and a dominance of red component within the object extracted from the lower part 22 of the image 18.

FIG. 2 shows another example of an image 28 with a vehicle 16 close to the front of the vehicle equipped with the camera assembly 10. Here again parts 24 of vehicle 16 appear similar to raindrops 26 due to the short distance between the vehicle equipped with the camera assembly 10 and the vehicle 16 in front of the latter.

The presence of a vehicle 16 in the near field of the view of the camera 12 may induce difficulties in detecting raindrops 26. Therefore the threshold value to which the confidence value assigned to an object extracted from the lower part 22 of a captured image 30, 32, 34 is compared, is modified as will be explained with reference to FIG. 3.

In a first step S10 the bifocal camera 12 captures an image 30, 32, 34 in which the upper part 20 is focused at infinity and the lower part 22 is focused on the windscreen. From this dual focus image 30, 32, 34 the upper part 20 is analyzed for obstacle detection in a step S12. This detection of the obstacle or item such as the vehicle 16 can be performed by processing the upper part 20 of the image 30. Alternatively or additionally a detector like a ultrasonic detector and/or a radar detector can be utilized to detect the presence of the vehicle 16 in front of the vehicle equipped with the camera assembly 10.

In a step S14 objects are extracted from the lower part 22 of the captured image 30, 32, 34. In a next step S16 the extracted objects are labelled. This classification or labelization of the objects within the lower part 22 of the captured image 30, 32, 34 is based on a set of descriptors which may describe object shape, intensity, texture, contrast or the like. Based on the descriptors, a selection of objects is performed in a step S18. This selection leads to a list of potential raindrops 26 within the lower part 22 of the captured image 30, 32, 34. In establishing this list of potential raindrops a confidence value or score is assigned to each potential raindrop in a step S20.

After detection of an item such as the vehicle 16 within the upper part 20 of the captured image 30 the distance of the vehicle 16 from the camera 12 is determined in a step S22. For example, if the vehicle 16 is closer than 5 meters, especially at a distance of 3-4 meters from the camera 12, the threshold value with which the confidence value is compared is increased. On the contrary, if vehicle 16 is relatively far from the camera's 12 field of view, for example at a distance of more than four meters, in a step S24 a standard threshold value is utilized for comparison with the confidence value. For the example with confidence values between −100 and 100, the threshold value selected in step S24 may be 0. On the other hand, if the vehicle 16 is not far but close to the camera 12, an increased threshold value is utilized for comparison with the confidence value in step S26. For a vehicle 16 at a distance between 3 and 4 meters from the camera 12 the increased threshold value selected in step S26 can have a value of 50, if the confidence value can vary between −100 and 100.

In a step S28 it is determined whether the confidence value is above the threshold value selected in step S24 or step S26 respectively. If this is the case, in a step S30 the object extracted from the lower part 22 of the captured image 30, 32, 34 is identified as a raindrop. If not, in a step S32 the object is rejected, i.e. the extracted object is identified as a non-drop.

Depending on the number and size of raindrops 26 on the windscreen, the wiper blades may be switched on or driving assistance systems can be activated such as a braking assistance system and/or the switching on of headlights of the vehicle equipped with the camera assembly 10. Additionally or alternatively the driver can be alerted that rainy conditions are present.

As in case of the presence of a vehicle 16 or such an item closely in front of the camera 12 the threshold value is modified, a higher confidence is necessary in order to identify an object extracted from the lower part 22 of the image as a raindrop 26. Alternatively the raindrop 26 detection process can be interrupted during the period of the presence of the vehicle 16 or such an obstacle or item in front of the vehicle equipped with a camera 12. As soon as the vehicle 16 is far enough away from the vehicle equipped with the camera 12, the raindrop detection utilizing the lower, standard threshold value can be resumed.

1. A method for detecting raindrops on a windscreen of a vehicle, comprising:
capturing at least one image is captured by a camera,
wherein characterized in that an object extracted from the at least one image 34) captured by the camera is identified as a raindrop, if a confidence value assigned to the extracted object is above a predetermined threshold value,
wherein the threshold value is modified in dependence of the presence of an item within the vehicle path.

2. The method according to claim 1, wherein the threshold value is modified in dependence of the presence of an item within the camera's field of view.

3. The method according to claim 1, wherein the threshold value is increased, if a distance between the camera and the item and/or between the vehicle and the item is lower than a predetermined distance.

4. The method according to claim 1, wherein a contour and/or the contrast and/or an intensity of the extracted object is considered for identifying the object as a raindrop.

5. The method according to claim 2, wherein the presence of the item within the camera's field of view is determined by means of the camera.

6. The method according to claim 1, wherein the presence of the item within the vehicle path is determined by a detection means configured to emit and receive a signal reflected by the item .

7. The method according to claim 1, wherein the image is captured by a bifocal camera, wherein the raindrop detection is performed for objects extracted from an image area of the captured image, which is focused on the windscreen.

8. The method according to claim 7, wherein the presence of the item is determined within another image area of the captured image, which is focused at infinity.

9. The method according to claim 1, wherein a supervised learning machine is utilized to identify raindrops among objects extracted from the at least one image.

10. The method according to claim 1, wherein the threshold value is reset to a predetermined value, if the item is no longer present within the vehicle path.

11. A camera assembly for detecting raindrops on a windscreen of a vehicle, comprising a camera for capturing at least one image, the camera assembly comprising:
evaluation means configured to:
identify an object extracted from the at least one image captured by the camera as a raindrop, if a confidence value assigned to the extracted object is above a predetermined threshold value; and
modify the threshold value in dependence of the presence of an item within the vehicle path.
